(19) United States
(12) Patent Application Publication
(10) Pub. No.: US 2011/0135811 A1
(43) Pub. Date: Jun. 9, 2011

(54) SOLUTION FOR INHIBITING PALLADIUM ACTIVITY INCLUDING HALOGENIC ACID AND METHOD FOR PREVENTING DEFECT OF PLATING USING THEREOF

(75) Inventors: Hyuk-Jin Kwon, Suwon-si (KR); Hyo-Seung Nam, Hwasung-si (KR); Tae-Ho Kim, Suwon-si (KR); Jong-Sik Kim, Seoul (KR); Jung-Wook Seo, Hwasung-si (KR)

(73) Assignee: SAMSUNG ELECTRO-MECHANICS CO., LTD.

(21) Appl. No.: 12/758,442

(22) Filed: Apr. 12, 2010

(30) Foreign Application Priority Data
Dec. 4, 2009 (KR) 10-2009-0120072

(51) Int. Cl. B05D 5/12; C09D 5/00

(52) U.S. Cl. 427/98.8; 106/287.27; 106/287.26

(57) ABSTRACT

Disclosed is a solution for inhibiting palladium activity including an aqueous halogenic acid solution as a pre-treatment solution which may be used before an electroless plating of a printed circuit board to prevent bad plating and a method for preventing bad plating by using the same. More particularly, disclosed is a solution for inhibiting palladium activity including 0.1 to 10 mol of an aqueous halogenic acid solution as a pre-treatment solution which may be used before an ENIG plating or ENEPIG plating of a printed circuit board to prevent bad plating.

Disclosed is also a method for preventing bad plating by minimizing defects of shorts between patterns which are caused by plating spreading during the surface treatment of a printed circuit board having fine patterns.

### CROSS-REFERENCE TO RELATED PATENT APPLICATIONS

This application claims the benefit of Korean Patent Application No. 10-2009-0120072, filed on Dec. 4, 2009, in the Korean Intellectual Property Office, the disclosure of which is incorporated herein in their entirety by reference.

### BACKGROUND OF THE INVENTION

1. Field of the Invention

The present invention relates to a solution for inhibiting palladium activity including an aqueous halogenic acid solution as a pre-treatment solution to prevent bad plating before ENIG plating or ENEPIG plating of a printed circuit board, and a method for preventing bad plating by using the same.

2. Background Art

There have been developed to reduce or eliminate linking phenomenon between patterns caused by bridge or short problems or plating spreading when plating precipitates such as Ni, Pd, and Au, etc. are deposited and plated on the surface of a board after ENIG(Electroless Nickel Immersion Gold) or ENEPIG(Electroless Nickel Electroless Palladium Immersion Gold) plating, as gaps between wires of a printed circuit board become finer.

In order to improve plating spreading, Ni(CN)₂ has been used after palladium catalyst treatment. However, it causes un-plated parts(Ni skip defects) and plating spreading according to treatment conditions.

Further, such cyano compounds are toxic and environmental unfriendly materials so that they may be restricted in use and it may eventually require replacing them.

Since wire spaces of PCBs become narrower more and more, a lot of effort is required to minimize defects of plating or plating spreading

### SUMMARY

The inventors of the present invention have completed the invention by providing a method for minimizing short defects between patterns which is caused by plating spreading during the surface treatment of PCBs having fine patterns.

An aspect of the present invention features a surface treating solution of PCBs which may minimize bad plating.

According to an aspect, there is provided a solution for inhibiting palladium activity including 0.1 to 10 mol of an aqueous solution of halogenic acid as a pre-treatment solution, which may be performed after palladium catalyst treatment in an electroless metal plating of a printed circuit board and prior to ENIG(Electroless Nickel Immersion Gold) plating or ENEPIG(Electroless Nickel Electroless Palladium Immersion Gold) plating, to prevent bad plating.

According to an embodiment, a concentration of the aqueous halogenic acid solution may be 0.5 to 5 mol.

According to an embodiment, the solution of inhibiting palladium activity may further include a cyano compound.

According to an embodiment, the cyano compound may be at least one chosen from KCN and NaCN.

According to an embodiment, a concentration of the cyano compound may be 10 to 200 ppm.

According to an embodiment, the solution for inhibiting palladium activity may further include an amine compound.

According to an embodiment, the amine compound may be at least one chosen from ethanol amine compound and diethanol amine compound.

According to another aspect, there is provided a method for preventing bad plating, the method including: grease removing and etching a board; performing pre-treatment with a palladium catalyst on the grease removed- and etched-board; immersing the palladium catalyst-treated board into a solution for inhibiting palladium activity including 0.1 to 10 mol of an aqueous halogenic acid solution; and performing ENIG plating or ENEPIG plating on the immersion-treated board.

According to an embodiment, the immersion may be performed for 1 to 10 minutes.

According to an embodiment, the halogenic acid may be chosen from HF, HCl, HBr and HI.

According to an embodiment, the method for preventing bad plating may hinder a spreading phenomenon of plating material by forming complexes between halogen ions of the halogenic acid and palladium remaining on the surface of a board.

According to an embodiment, the method for preventing bad plating may minimize short defects between patterns which are caused by plating spreading during the surface treatment of a board.

### BRIEF DESCRIPTION OF THE DRAWINGS

FIG. 1 shows a board illustrating minimized plating spreading by deactivating palladium activity during the surface treatment of a printed circuit board having fine patterns.

FIG. 2 shows a board plated according to Comparison Example 1, except no inhibiting process of the palladium activity.

FIG. 3 is a board plated according to Example 1 which includes treating with a palladium catalyst, immersing the board into an aqueous HCl solution for 5 minutes and performing an electroless nickel plating.

### DETAIED DESCRIPTION

The present invention is described in more detail hereinafter.

When a semi additive process is used to manufacture a board, holes through the board are made by drilling and chemical plating is performed with ionized form of a palladium catalyst on the surface of the board. The palladium catalyst herein is a palladium catalyst, which is reduced to metal, and dispersed over the surface of the board even after forming lines with etching. Thus, it may cause plating spreading during the electroless surface treatment.

However, a board in the present invention is made by forming holes by drilling through a copper clad laminate(CCL) and chemical plating thereto in which only holes are chemical-plated and at the rest thereof the copper layer is chemical-plated. After chemical plating, patterning, exposure and etching etc. are performed. Unlike the semi additive process, ionized form of palladium catalyst is not remained on the board and this process is called as a subtractive process.

In the subtractive process, the ionized form of palladium catalyst may not remain but other forms of palladium catalyst may. Thus, a palladium catalyst, which reacts only with copper patterns, is used in the subtractive process and such catalyst is called as a substitution palladium catalyst since it is only substituted with a metal. Ionized form or colloid form of palladium catalyst, not metal form, is used. When an insulating material having high roughness is used, because such palladium catalyst cannot be rinsed out well and thus remained, it may cause spreading of nickel plating during the electroless plating process.

The present invention is therefore to provide a solution for deactivating such substitution palladium catalyst to inhibit the palladium activity and reducing plating spreading during the plating process.

Thus, the present invention is not to eliminate the palladium catalyst which is reduced to the corresponding metal being remained on a board in the semi additive process, but to deactivate ionized form or colloid form of remaining palladium catalyst.

According to the present invention, there is provided a solution for inhibiting palladium activity including 0.1 to 10 mol of an aqueous halogenic acid solution as a pre-treatment solution which may be used after palladium catalyst treatment in an electroless metal plating of a printed circuit board and prior to ENIG(Electroless Nickel Immersion Gold) plating or ENEPIG(Electroless Nickel Electroless Palladium Immersion Gold) plating, to prevent bad plating.

When it is used less than 0.1 mol, it may not be enough to deactivate the palladium catalyst and thus cause spreading of nickel plating. On the other hand, when it is used more than 10 mol, it may eliminate spreading problem but generate harmful gas to human body and cause equipment corrosion so that it is not proper against environmental points.

A concentration of the aqueous halogenic acid solution may be 0.5 to 5 mol, preferably 1 to 3 mol.

The halogenic acid may be chosen from HF, HCl, HBr and HI, preferably HCl in view of spreading, economy and equipment corrosion matters.

The aqueous halogenic acid solution, particularly aqueous HCl solution, may be used to minimize plating spreading after the palladium catalyst treatment in forming circuit patterns on a board by an electroless plating method.

The halogen ions of the halogenic acid form a complex with palladium on the surface to a board to deactivate them so that it inhibits plating spreading.

According to an embodiment, the inhibiting solution may further include a cyano compound (CN-containing compound) such as KCN, NaCN, besides an aqueous halogenic acid solution.

The cyano compound may oxidize the palladium catalyst to palladium ions and eliminate them by etching. Here colloid form of palladium ions may be removed so that plating spreading may be reduced.

According to an embodiment, a concentration of the cyano compound may be about 10-200 ppm. When it is less than 10 ppm, it may still cause plating spreading since etching reaction is not enough and when it is more than 200 ppm, it may cause over-etching with a longer period treating and thus result in partial un-plating.

According to an embodiment, the inhibiting solution may further include an amine compound such as ethanol amine, diethanol amine, besides an aqueous halogenic acid solution.

The solution for inhibiting palladium activity may further include a wetting agent. Examples of the wetting agent may include a surfactant, an alcohol or an ether.

The surfactant may be cationic, nonionic or anionic surfactant and examples thereof may include ethyl alcohol, isopropyl alcohol, butanol, ethylene glycol, diethylene glycol, propylene glycol and dipropylene glycol. Examples of ether may include ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monoethyl ether, propylene glycol monobutyl ether, dipropylene glycol monomethyl ether, dipropylene glycol monobutyl ether, diethylene glycol dimethyl ether, dipropylene glycol dimethyl ether, polyoxyethylene methyl phenyl ether, polyoxyethylene ethyl phenyl ether, polyoxyethylene octyl phenyl ether and polyoxyethylene nonyl phenyl ether.

The solution for inhibiting palladium activity may be an aqueous solution such as dispersion or suspension but is not limited thereto.

A method for preventing bad plating during electroless plating process in manufacturing circuit patterns of an insulating layer may include: degreasing and etching a board; performing pre-treatment with a palladium catalyst on the grease removed- and etched-board; immersing the palladium catalyst-treated board into a solution for inhibiting a palladium activity an aqueous halogenic acid solution; and performing ENIG plating or ENEPIG plating on the immersion-treated board.

According to an embodiment, the immersion may be performed for 1 to 10 minutes. Particularly, when the solution for inhibiting palladium activity is circulated or a board is shaken in the immersion step, the inhibition effect may be increased.

When the immersion time is less than 1 minute, it may cause plating spreading and when it is more than 10 minutes, it may cause etching of copper patterns.

The method may further include rinsing the palladium catalyst-treated board with water before and after the immersion of the solution for inhibiting palladium activity including an aqueous halogenic acid solution.

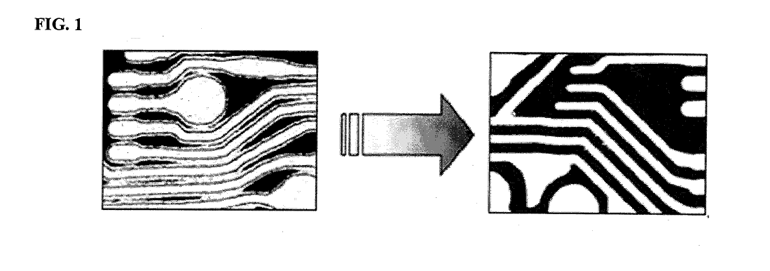

FIG. 1 is an image illustrating minimized plating spreading by inhibiting the palladium activity during the surface treatment of PCBs having fine patterns with an electroless nickel plating.

While the present invention has been described with reference to particular embodiments, it is to be appreciated that various changes and modifications may be made by those skilled in the art without departing from the spirit and scope of the present invention, as defined by the appended claims and their equivalents. Throughout the description of the present invention, when describing a certain technology is determined to evade the point of the present invention, the pertinent detailed description will be omitted

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, although more detailed descriptions will be given by examples, those are only for explanation and there is no intention to limit the invention.

### COMPARISON EXAMPLE 1

### Pretreatment of a Solution for Inhibiting Palladium Activity

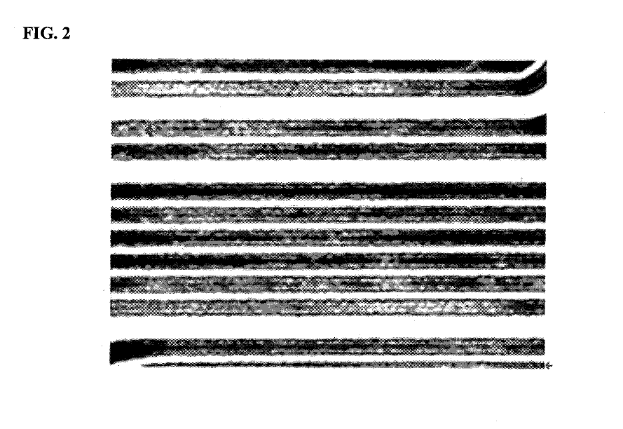

An electroless nickel plating was preformed after degreasing and etching a circuit board and then treating a palladium catalyst. FIG. 2 shows a board plated without an inhibition process of palladium activity after treating a palladium catalyst according to Comparison Example 1.

It is noted in FIG. 2 that there is plating spreading in the electroless nickel plating.

### EXAMPLE 1

### HCl Treatment as a Solution for Inhibiting Palladium Activity

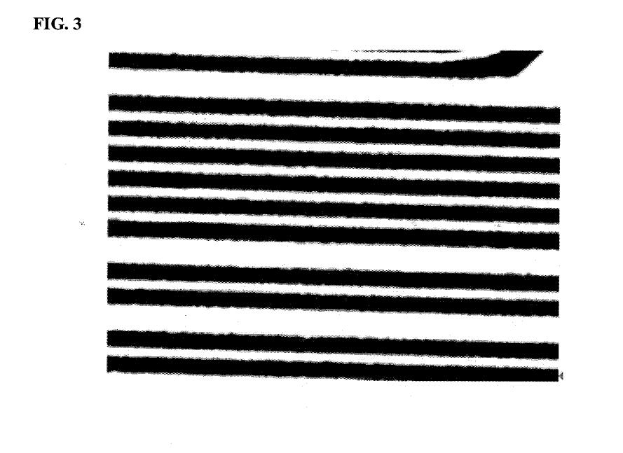

An electroless nickel plating was preformed after preparing an insulting circuit board, treating it with a substitution palladium catalyst, immersing it into 2 mol of aqueous HCl solution for 5 minutes and rinsing it. FIG. 3 shows the surface of a board plated by treating a board with a palladium catalyst, immersing it into aqueous HCl solution for 5 minutes and performing an electroless nickel plating according to Example 1.

It is noted in FIG. 3 that it shows no partial un-plating and less spreading, compared to the board plated according to Comparison Example 1.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

Many other embodiments can be included in the scope of claims of the present invention.

What is claimed is:

1. A solution for inhibiting palladium activity comprising 0.1 to 10 mol of an aqueous halogenic acid solution as a pre-treatment solution which is used after palladium catalyst treatment in an electroless metal plating of a printed circuit board and prior to ENIG (Electroless Nickel Immersion Gold) plating or ENEPIG (Electroless Nickel Electroless Palladium Immersion Gold) plating to prevent bad plating.

2. The solution of claim 1, wherein a concentration of the aqueous halogenic acid solution is 0.5 to 5 mol.

3. The solution of claim 1, wherein the halogenic acid is selected from the group consisting of HF, HCl, HBr and HI.

4. The solution of claim 1, wherein the halogen ions of the halogenic acid form a complex with palladium on the surface of a board to be deactivated and thus prevent plating spreading.

5. The solution of claim 1 further comprising a cyano compound.

6. The solution of claim 5, wherein the cyano compound is at least one selected from the group consisting of KCN and NaCN.

7. The solution of claim 5, wherein a concentration of the cyano compound is 10 to 200 ppm.

8. The solution of claim 1 further comprising an amine compound.

9. The solution of claim 8, wherein the amine compound is at least one selected from the group consisting of ethanol amine compound and diethanol amine compound.

10. A method for preventing bad plating in an electroless metal plating of a printed circuit board comprising:
grease removing and etching a board;
performing treatment with a palladium catalyst on the grease removed- and etched-board;
immersing the palladium catalyst-treated board into a solution for inhibiting a palladium activity comprising 0.1 to 10 mol of an aqueous halogenic acid solution; and
performing ENIG plating or ENEPIG plating on the immersion-treated board.

11. The method of claim 10, wherein a concentration of the aqueous halogenic acid solution is 0.5 to 5 mol.

12. The method of claim 10, wherein the immersion is performed for 1 to 10 minutes.

13. The method of claim 10, wherein the halogenic acid is selected from the group consisting of HF, HCl, HBr and HI.

14. The method of claim 10, wherein the halogen ions of the halogenic acid form a complex with palladium on the surface of a board to be deactivated to prevent plating spreading.
